(19) United States
(12) Patent Application Publication
(10) Pub. No.: US 2005/0127205 A1
(43) Pub. Date: Jun. 16, 2005

(54) Method and device for the hydro-erosive rounding of an edge of a component

(75) Inventors: Andreas Fath, Erlangen (DE); Helmut Hummel, Hohenburg (DE); Christoph Klesse, Worth A.D. Donau (DE)

Correspondence Address: Andreas Grubert;Baker Botts L.L.P., One Shell Plaza, 910 Louisiana, Houston, TX, 77002-4995, US

(73) Assignee: Siemens Aktiengesellschaft

(21) Appl. No.: 11/028,927

(22) Filed: Jan. 4, 2005

Related U.S. Application Data
(63) Continuation of application No. PCT/DE03/02023, filed on Jun. 17, 2003.

(30) Foreign Application Priority Data
Jul. 4, 2002 (DE) 10230170.0

(51) Int. Cl. B05B 3/10

(52) U.S. Cl. 239/223

(57) ABSTRACT

In a method and a device for the hydro-erosive rounding of an edge of a component, in particular, an edge in a channel of a high-pressure resistant component, a fluid charged with abrasive bodies is run along the edge for rounding and the flow speed in the vicinity of the edge for rounding is increased by means of a body arranged in the fluid flow path. With relation to the method, the flow speed of the fluid (6) is increasingly raised along the course of the body (7) until the edge (5) for rounding is reached by means of the geometry of the body (7) and, with relation to the device, the cross-sectional area of the flow channel (10) continuously declines in the direction of flow (S) of the fluid (6) along the length of the body (7) at least as far as the edge (5).

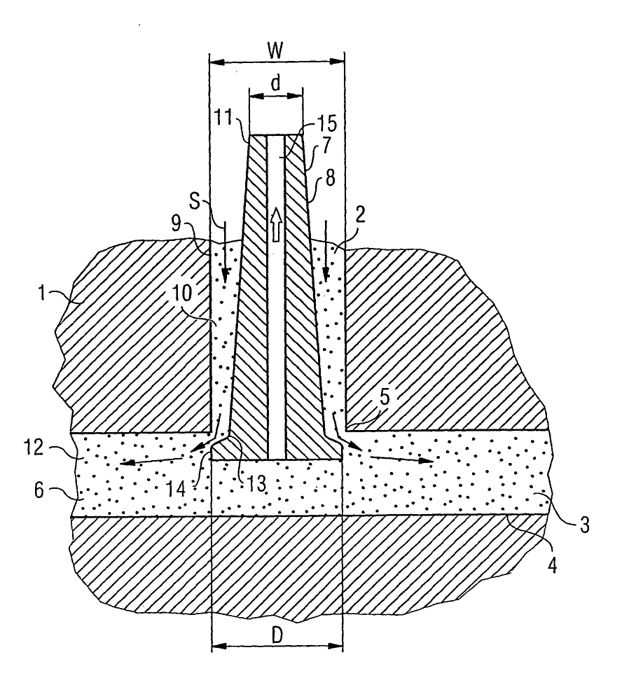

### CROSS REFERENCE TO RELATED APPLICATION

This application is a continuation of copending International Application No. PCT/DE03/02023 filed Jun. 17, 2003 which designates the United States, and claims priority to German application no. 102 30 170.0 filed Jul. 4, 2002.

### TECHNICAL FIELD OF THE INVENTION

The present invention relates to a method for the hydro-erosive rounding of an edge of a component, in particular, an edge in a channel of a high-pressure resistant component, whereby a fluid charged with abrasive bodies is run along the edge for rounding and the flow speed in the vicinity of the edge for rounding is increased by means of a body arranged in the fluid flow path. The invention also relates to a device for the hydro-erosive rounding of an edge of a component, in particular, an edge in a channel of a high-pressure resistant component, with a body arranged in the flow path of a fluid charged with abrasive bodies and in the vicinity of the edge for rounding to increase the flow speed of the fluid, whereby the body forms a flow channel in the flow direction, with a wall preceding the edge and bordering the edge, in particular to implement the above-mentioned method.

### DESCRIPTION OF THE RELATED ART

Cutting bores in high-pressure resistant components, in particular, components of fuel injection systems to counteract any local spikes that could lead to component fatigue or destruction, is common knowledge. In a rounding method, also known as extruder honing, a polymer paste charged with abrasive particles rounds the edges of the cut. A disadvantage is the high running costs for the purchase and disposal of the polymer abrasive paste as well as a very cost-intensive cleaning process to remove the abrasive paste from the component. Moreover, with fuel injection systems, there is the danger of the paste being displaced within the common-rail system, for example downstream to the nozzle. This can lead to the spray holes in the nozzle being blocked or to the nozzle losing its sealing function in the area of the nozzle valve and hence finally to a drop in power, engine failure or even to engine damage.

A further generally known state-of-the-art option for rounding edges is to use an electro-chemical method of removing material. Here, the edge in the area of the intercut bores is also rounded. Of particular disadvantage here are the pore-like raw surfaces that occur and which lead to local spikes. Thus the achievable increase in pressure with this method is lower than with the extruder honing method.

Another method known as autofrettage does not round the edges, but generates an increased compression strength by generating internal stresses, which act in the opposite direction to the compressive strains arising when the component is in operation. In autofrettage, the component is put under stress for a few minutes. The pressure imposed is selected so high that plastic deformations occur locally and the plastic deformations do not arise through the entire wall thickness of the component, but only partially (about 50%). The outer area of the wall is only elastically deformed and the inner area plastically. When the pressure is released, internal stresses arise in the inner area. This internal stress acts in the opposite direction to the compressive strain in the sense of a counter stress. This method is, however, not suitable as a standard procedure as it requires pressures of several thousand bars.

Furthermore German patent application DE 199 53 131 AI discloses a method and a device for rounding edges in mechanically, thermally or otherwise highly stressed components. Rounding edges on cuts of channels in high pressure accumulators in fuel injection systems is named as a special area of application. In such highly stressed components, all kinds of spikes occur in the edge area, which can lead to a component failure, in particular to a component tearing. To ensure the high-pressure resistancy of a component, its edges are rounded. The rounding is achieved by circulating an erosive fluid round the edge for rounding, said erosive fluid being conveyed through the component by means of a feed pump. In the edge area, flow speed of the fluid is increased by tapering the cross section in order to increase the erosive effect of the fluid. The flow speed of the fluid and hence also the removal of material in the edge area can be influenced by adjusting the delivery pressure. The delivery pressures lie around the range of 50 bar to 140 bar. Moreover, it is generally said, without giving further details that the flow direction of the fluid and the longitudinal axis of the edge for rounding preferably incorporate an angle of 90°. For rounding the edge type transition of a nozzle valve seat and of an adjacent antechamber to the injection holes of an injection nozzle, a description is given there of introducing a conical body into the vicinity of the nozzle valve seat of the pocket hole type injection nozzle in such a way that an annular gap arises in the vicinity of the edge. This annular gap is used to achieve the desired increase in the flow speed in the vicinity of the edge for rounding. Moreover, one can see from the related figure in this patent application that the annular gap widens in the flow direction. Aside from the essential functions of the body to increase the flow speed of the erosive fluid, there are no further details contained as to the design of the body, in particular with regard to its circumferential surface contour.

From the German patent DE 199 14 719 C2 a further device for the hydro-erosive rounding of the pitch edge of a spray hole in a fuel injection nozzle is also known. Contrary to the previously described rounding device with a conical flow body for increasing the flow speed of the erosive fluid, here, a flow body is provided, which models the form of a nozzle valve. Correspondingly, the flow body is made up of a shaft whose outer diameter for forming a ring channel for the erosive fluid is minimally smaller than the inner diameter of the cylinder shaped guide bore in the injection nozzle for the nozzle valve. A cylinder shaped point is attached to the front end of the shaft of the flow body, said point becoming a cone shaped seat taper at its further end. The outside contour of the seat taper matches the inside contour of the seat cone of the injection nozzle. Moreover, the outside diameter of the point and of the seat taper are selected so that the seat taper is below and adjacent to the spray hole and is close to the seat cone of the injection hole. The channel for the erosive fluid formed by the flow body thus terminates in the vicinity of the spray hole. The flow speed of the erosive fluid entering from the ring channel between the inside wall of the guide bore and the outside wall of the shaft of the flow body into the area of the seat cone space, first decreases, as the ring channel widens considerably in the vicinity of the beginning of the point. Then the flow speed of the erosive fluid is increased again in the vicinity of the seat cone in the direction of the spray hole, as in the direction of the point of the flow body, the cone-shaped inside wall of the seat cone tapers to the cylindrical outside wall of the point.

In addition, guide grooves running lengthwise can be incorporated in the outside wall of the point, via which guide grooves, the abrasive bodies of the erosive fluid can be specifically routed to the upper area of the pitch edge of the spray hole. This should result in stronger rounding in this area, which in turn should lead to a higher rate of flow of the fuel.

### SUMMARY OF THE INVENTION

The object of the present invention is to create a method and a device for the hydro-erosive rounding of an edge of a component, in particular, an edge in a channel of a high-pressure resistant component, said method and device achieving an optimization of the rounding result, preferably a concentration of the rounding on the edge area.

According to the invention, with a method for the hydro-erosive rounding of an edge of a component, in particular, an edge in a channel of a high-pressure resistant component, whereby a fluid charged with abrasive bodies is run along the edge for rounding and the flow speed in the vicinity of the edge for rounding is increased by means of a body arranged in the fluid flow path, the flow speed of the fluid is increasingly raised along the course of the body until the edge for rounding is reached by means of the geometry of the body, and the highest flow speed, and hence the greatest abrasive effect of the erosive fluid, is reached exactly in the vicinity of the edge. Because of the high flow speeds that can be achieved locally via the body, all in all, the entire rounding method can be operated with a lower pressure from the feed pump for the erosive fluid. In a preferred embodiment of the method, the flow speed of the fluid is increasingly raised by means of the geometry of the body, whereby the body and an adjacent wall of the component are also protected from abrasive attack by the erosive fluid, as the erosive fluid flows essentially parallel to the peripheral area of the body or to the wall.

To further optimize the abrasive effect of the erosive fluid, the fluid in flow direction is deflected by the body towards the edge for rounding. By this means, the abrasive bodies contained in the fluid will flow against the edge with a vertical velocity component. The impact then causes material to be eroded in the vicinity of the edge. Thus the body also has a targeted influence on the velocity vectors of the flow.

Further, as with the method described above, an optimization of the rounding result is achieved according to the invention in the case of the device for the hydro-erosive rounding of an edge of a component, in particular an edge in a channel of a high-pressure resistant component, with a body arranged in the flow path of a fluid charged with abrasive bodies and in the vicinity of the edge for rounding to increase the flow speed of the fluid, whereby the body forms a flow channel with a wall in the flow direction of the fluid preceding the edge and bordering the edge, by the fact that the cross-sectional area of the flow channel continuously declines in the flow direction of the fluid along the course of the body at least as far as the edge. The continuous decline of the cross-sectional area of the flow channels protects the body and the adjacent wall of the component from excessive wear.

As with the method according to the invention described above, the rounding of the edge is further optimized by forming the area of the peripheral area of the body that is opposite the edge, in such a way that the flow of the fluid is deflected, at least in part, onto the edge.

In a preferred embodiment of the invention, at an edge for rounding in the component, which edge has been formed by cutting the end of a first bore with cylindrical cross section into a second bore, a ring-shaped flow channel is formed using the body centrally inserted into the first bore between the peripheral area of the body and the wall of the first bore. By means of the evenly increased flow speeds over the entire flow channel achieved by this, an even rounding of the edge in its flow direction is attained.

In order to achieve the optimization described previously of the rounding effect in a cylinder shaped bore, the body has a guide section, which widens in the flow direction of the fluid, preferably shaped as a cone section, to which guide section a deflector section connects in the flow direction of the fluid, said deflector section widening arc-shaped in the direction of the edge. Thus the erosive fluid runs against the edge at a propitious angle for the wearing effect. To achieve this, the depth to which the body is inserted into the first bore is advantageously selected so that the deflector section of the body in the flow direction of the fluid is on a level with the edge. In a preferred embodiment, the body is designed as a hollow body with a channel, via which the fluid is carried away again from the component (1) after it has flowed past the edge for rounding. It is also possible to vary the relative position of the flow body to the edge for rounding even during the grinding process.

### BRIEF DESCRIPTION OF THE DRAWINGS

The present invention is explained in detail below with reference to an exemplary embodiment represented in a drawing. The single FIGURE shows a schematic sectional view of a section of a high-pressure resistant component 1 of a fuel injection system, such as, for example, of an injection nozzle, of a forged rail, of a welded rail, of the displacement unit of a common-rail high pressure pump or for the high pressure area of a common-rail high pressure pump. The component 1 has a supply channel and a main channel, which are formed in the shape of a first bore 2 and a second bore 3. The first bore 2 leads into bore 3 in the area of the wall 4 of the second bore 3. In the area in which the bores 2 and 3 come together, a circumferential edge 5 is formed in the component 1, said edge being square-edged once the bores 2 and 3 have been made. In the preferred embodiment, the longitudinal extensions of the two bores 2 and 3 come together at a right angle.

### DETAILED DESCRIPTION OF THE PREFERRED EMBODIMENTS

In order to round such an edge 5 to increase the high pressure resistance of the component 1, a fluid 6 charged with abrasive bodies, preferably a very viscose lubricating oil, is fed into the first bore 2 by means of a feed pump, which is not illustrated, and flows along the edge 5. In order to increase the erosive effect of the fluid in the vicinity of the edge 5, a body 7 is introduced into the first bore 2 in the vicinity of the edge 5. The outer peripheral area 8 of the body 7 is proportioned such that an annular gap 10 is formed between the wall 9 of the first bore 2 and the peripheral area 8. By maintaining the delivery pressure of the feed pump, the cross-sectional area of the first bore 2 is reduced and the flow speed in the vicinity of the annular gap 10 and hence also in the vicinity of the edge 5 is increased. The increase in the flow speed causes a corresponding increase in the erosive effect of the fluid charged with the abrasive bodies. Moreover, the body 7 must only increase the flow speed for the rounding locally by reducing the flow cross section in the vicinity of the edge 5. In this way, the erosive rounding can also be carried out using adequate pressures in the region of approximately 10 bar to 500 bar.

The fluid can leave the component 1 after the grinding process via two routes, both of which are indicated in the sole FIGURE. If the body 7—as shown—is designed as a hollow body with a central channel 15, the ends of the second bore 3 are closed and the fluid will flow past the edge 5 and then, after a corresponding diversion, leave the second bore 3 via the channel 15, the end of which channel is connected to a recirculation pipe which is not illustrated. An alternative second flow path for the fluid results if the body 7 is designed as a solid body. Then the fluid leaves the component 1 after the grinding process via the second bore 3, which, in this case, is not closed.

In order to achieve the desired reduction of the flow cross section, with a first bore 2 designed as a cylinder bore with the corresponding constant diameter, the body 7 is formed essentially as a rotationally symmetrical cone with a cone-shaped guide section 11. Correspondingly, the flow channel 10, formed after the insertion of the body 7 into the first bore 2, has—in the flow direction of the fluid 6—a continuously declining cross-sectional area with the accompanying increase in flow speed. Hereby the body 7 is centrally arranged in the first bore 2 and the flow channel 10, therefore, has at the same level a constant width all round in flow direction S. Thus the longitudinal axis of the body 7 and the longitudinal axis of the first bore 2 coincide.

In addition to the increase in the flow speed, which is advantageous for the rounding, the body 7 also has the function of directing the flow of the fluid in the direction of the edge 5. This results in a further increase in the erosive effect of the fluid 6 as this effect is essentially determined by the impetus of the abrasive bodies 12 flowing with a vertical velocity component against the edge 5. For this purpose, the body 7 has, in addition to the previously described guide section 11, connecting to its end with the larger diameter, a deflector section 13 for directing the fluid 6 in the direction of the edge 5, said deflector section being followed by a cylinder-shaped flange section 14. The guide section 11 verges tangentially into the deflector section 13, which, seen in cross section, is directed outwards in an arc-shape. On the side opposite the guide section 11 the cylinder shaped deflector section 13 verges over a circumferential edge into the flange section 14. The body 7, in the embodiment described, is designed rotationally symmetrical to its longitudinal axis in the vicinity of the deflector section 13 and of the flange section 14 as well. The insertion depth of the body 7 into the first bore 2 is chosen so that the edge 5, in the flow direction S, is approximately at the same height as the centre of the deflector section 13. Preferably targeted variations to the relative position of the flow body 7 to the edge for rounding 5 during the grinding process can be made.

Further, it can be seen from the sole FIGURE that the body 7 has the biggest diameter D in the vicinity of its flange section 14, which diameter against the flow direction S to the end of the guide section 11 opposite the flange section 14 decreases down to the diameter d. In order to be able to insert the body 7 into the first bore 2 for the high-erosive rounding, the biggest diameter D of the body 7 is smaller than the clear opening W of the first bore 2.

1. A method for the hydro-erosive rounding of an edge of a component, in particular, an edge in a channel of a high-pressure resistant component, comprising the steps of:
running a fluid charged with abrasive bodies along the edge for rounding, and
increasing the flow speed in the vicinity of the edge for rounding by means of a body arranged in the fluid flow path, wherein the flow speed of the fluid is steadily and increasingly raised along the course of the body until the edge for rounding is reached by means of the geometry of the body.

2. The method according to claim 1, wherein the fluid in flow direction is deflected by the body in the direction of the edge for rounding.

3. A device for the hydro-erosive rounding of an edge of a component, in particular, an edge in a channel of a high-pressure resistant component, with a body arranged in the flow path of a fluid charged with abrasive bodies and in the vicinity of the edge for rounding to increase the flow speed of the fluid, whereby the body forms a flow channel in the flow direction of the fluid, with a wall preceding the edge and bordering the edge wall, wherein the cross-sectional area of the flow channel continuously declines in the flow direction of the fluid along the length of the body at least as far as the edge.

4. The device according to claim 3, wherein the vicinity of the peripheral area of the body, said vicinity being opposite the edge, is designed in such a way that the flow of the fluid is at least in part deflected onto the edge.

5. The device according to claim 3, wherein the edge in the component is formed by cutting the end of a first bore with cylindrical cross section into a second bore and the body centrally inserted in the first bore forms a ring shaped flow channel with the wall of the first bore.

6. The device according to claim 4, wherein the edge in the component is formed by cutting the end of a first bore with cylindrical cross section into a second bore and the body centrally inserted in the first bore forms a ring shaped flow channel with the wall of the first bore.

7. The device according to claim 3, wherein the body has a guide section which widens in flow direction of the fluid, to which guide section a deflector section connects in the flow direction of the fluid, which deflector section widens in an arc-shape in the direction of the edge.

8. The device according to claim 7, wherein the insertion depth of the body into the first bore is chosen so that the deflector section of the body in the flow direction of the fluid is on a level with the edge.

9. The device according to claim 8, wherein the guide section is designed as a cone section.

10. The device according to claim 3, wherein the body has a channel, via which the fluid is carried away again from the component after it has flowed past the edge for rounding.

11. A method for the hydro-erosive uniform rounding of an edge in its contour line in a channel of, in particular, a high-pressure resistant component, comprising the steps of:
running a fluid charged with abrasive bodies along the edge for rounding, and
increasing the flow speed in the vicinity of the edge for rounding by means of a body arranged in the channel, wherein the flow speed of the fluid is steadily and increasingly raised along the course of the body until the edge for rounding is reached by means of the geometry of the body.

12. The method according to claim 11, wherein the fluid is deflected by the body in the direction of the edge for rounding.
